(19) United States
(12) Patent Application Publication
(10) Pub. No.: US 2004/0226547 A1
(43) Pub. Date: Nov. 18, 2004

(54) Plasma coating for cylinder liner and method for applying the same

(76) Inventors: Johann Holzleitner, Gunskirchen (AT); Hans Reich, Thalheim bei Wels (AT); Friedrich Paschinger, Wels (AT); Wolfgang Muckenhuber, Gunskirchen (AT)

Correspondence Address: PILLSBURY WINTHROP, LLP, P.O. BOX 10500, MCLEAN, VA, 22102, US

(21) Appl. No.: 10/773,460

(22) Filed: Feb. 9, 2004

Related U.S. Application Data
(60) Provisional application No. 60/445,460, filed on Feb. 7, 2003.

(51) Int. Cl. F02B 75/08; F02F 1/00

(52) U.S. Cl. 123/668; 123/193.3

(57) ABSTRACT

A coating is plasma sprayed onto a cylinder bore and cylinder head sealing surface of a cylinder block of an internal combustion engine. The coating is harder and/or more wear resistant than the cylinder block, itself. A cylinder head mounts to the cylinder head sealing surface so that the coating is at least partially disposed between the cylinder block and the cylinder head. The coating therefore protects the cylinder block from exposure to the cavitating pressures that can develop in the combustion chamber of the cylinder. A depression is formed in the cylinder head sealing surface to account for the thickness of the coating. A chamfer is formed in the transition between the cylinder bore and the cylinder head sealing surface.

This application claims the benefit of U.S. Provisional Patent Application No. 60/445,460, filed on Feb. 7, 2003, which is incorporated herein by reference.

### BACKGROUND OF THE INVENTION

1. Field of the Invention

The present invention relates to the arrangement of a protective coating on a cylinder block of an internal combustion engine.

2. Description of Related Art

In cylinders for internal combustion engines that have plasma-coated cylinder running surfaces, the transition between the bore that is protected by the plasma and the cylinder head sealing surface poses a potential hazard if this transition is not protected against combustion pressure and/or pressure peaks caused by detonations by the cylinder head. Such protection is non-existent if the cylinder head and the cylinder block are formed by separate components and the cylinder head combustion chamber diameter is greater than the diameter of the cylinder bore. In this case, particularly when the engine is knocking, this can result in cavitation erosion of the unprotected material of the cylinder block, and consequently to the disintegration or loosening of the plasma coating, and thus to the failure of the cylinder.

U.S. Pat. No. 5,642,700 describes a method for plasma coating cylinder running surfaces that prevents the plasma coating from breaking away from the base material of the cylinder and thereby extends the service life of the cylinder. It is known that a plasma coating is applied to a cylinder running surface upon which the piston runs. The thickness of this coating can be between 30 μm and 200 μm, preferably between 30 μm to 100 μm. It is also known that the transition between the inside surface of the cylinder and the cylinder head sealing surface or cylinder head lower face can be configured so as to be convex. A plasma coating can similarly be applied to the transition in order to prevent combustion residues depositing on this surface. Unfortunately, final finishing of the cylinder head sealing surface can separate the thin outer edge of the coating from the cylinder block. Moreover, if a cylinder head has a larger inner diameter than the cylinder bore, the coating will not protect an upper surface of the cylinder block from combustion pressure.

U.S. Pat. No. 5,050,547 describes a plasma coated cylinder running surface in which the plasma coating ends at a distance from the face end of the cylinder sealing surface that is proximate to the cylinder head. One advantage of this embodiment is said to be that the plasma coating on the cylinder running surface cannot be loosened during final machining of the face end of the cylinder sealing surface. However, an upper edge of the cylinder block remains exposed to the cavitating pressure of the combustion chamber.

### SUMMARY OF THE INVENTION

It is therefore one aspect of one or more embodiments of this invention to provide a cylinder block coating and a process for coating a cylinder block in which the coating is securely attached to the cylinder block and protects the cylinder block from exposure to the cavitating pressure that can develop in the combustion chamber.

Another aspect of one or more embodiments of this invention provides a cylinder block coating that protects the cylinder block even if the cylinder head has a significantly larger inner diameter than the cylinder bore.

Another aspect of one or more embodiments of this invention provides a cylinder or cylinder block that possesses a high mechanical load bearing capacity even if the diameters of the cylinder and the combustion chamber are different.

This objective has been achieved in that the sealing surface for the cylinder head is at least partially coated. It is also solved by a method for at least partially providing a finished coating on the cylinder head sealing surface surrounding the cylinder bore. It is advantageous that even in the case of different diameters for the cylinder and the combustion chamber, cavitation can be prevented by the coating on the chamfer that forms the transition between the cylinder bore surface and the cylinder head sealing surface on the area surrounding the cylinder bore. The coating is continued right into the cylinder head sealing surface and the cylinder head covers the transition area that incorporates the chamfer by appropriate selection of the diameter of the combustion chamber, so that even under unfavorable combustion conditions, the coating is not destructed.

In addition, a step or a depression can be arranged in the area of the cylinder head sealing surface that adjoins the chamfer, and this is coated with the second material, so that a coating surface that is level with the uncoated portion of the cylinder head sealing surface is formed and, as viewed radially relative to the cylinder bore, a diameter of the step or depression is greater than the inside diameter of the combustion chamber in the area of the cylinder head sealing surface. In this connection, it is advantageous that it is possible to prevent cavitation erosion in the depressed area of the cylinder head sealing surface. However, it is also an advantage that a coating need be applied only in the area of the step or depression and not to the whole of the cylinder head sealing surface, so that it is possible to reduce at least the cost of materials.

Another aspect of one or more embodiments of this invention provides a cylinder block assembly for an internal combustion engine. The assembly includes a cylinder block having a cylinder bore formed therein extending from a first surface. The cylinder bore has a cylinder bore surface and is formed from a first material. The first surface defines a cylinder head sealing surface. The assembly also includes a cylinder head mounted to the cylinder head sealing surface, and a coating covering at least part of the cylinder bore surface and at least part of the cylinder head sealing surface. The coating is made from a second material that is different from the first material. The coating has a truncated outer edge.

According to a further aspect of one or more embodiments of this invention, a portion of the coating that covers at least part of the cylinder head sealing surface extends radially outwardly from the cylinder bore in a plane that is perpendicular to an axis of the cylinder bore. The coating may extend radially outwardly at least 1 mm beyond the cylinder bore.

According to a further aspect of one or more embodiments of this invention, a the cylinder block includes a chamfer formed in a transition area between the cylinder bore and the cylinder head sealing surface. The coating covers the chamfer. The chamfer may be frusta-conical. A height of the frusta-conical chamfer in an axial direction of the cylinder bore is between 0.1 mm and 2.5 mm. The frusta-conical chamfer may be inclined at an angle of between 15° and 70° to the cylinder bore. Transitions in the cylinder block between the cylinder bore and the chamfer and between the chamfer and the cylinder head sealing surface are preferably rounded. The coating on the chamfer may or may not be finished.

According to a further aspect of one or more embodiments of this invention, a depression is disposed in the first surface of the cylinder block. The depression surrounds the cylinder bore and is covered by the coating. The portion of the coating covering the depression has a surface that is level with an uncoated portion of the cylinder head sealing surface. The depression may have a diameter that is greater than an inside diameter of the cylinder head at the intersection between the cylinder head and the sealing surface. A portion of the coating that covers the depression is preferably finished. The depression may have a substantially uniform depth and a portion of the coating that covers at least part of the cylinder head sealing surface may have a substantially uniform thickness. The depression may have a minimum depth, relative to the first surface. This minimum depth is preferably at least 0.01 mm, is more preferably at least 0.05 mm, and is more preferably at least 0.07 mm. The depression may have a step that abuts the truncated outer edge of the coating. The portion of the coating that covers the depression has a corresponding minimum thickness that is preferably at least 0.01 mm, is more preferably at least 0.05 mm, and is more preferably at least 0.07 mm.

A recess for a cylinder head gasket may be formed in the cylinder head sealing surface of the cylinder block and surround the cylinder bore. The coating extends outwardly over the cylinder head sealing surface to an inner edge of the recess.

Another aspect of one or more embodiments of the present invention provides a method for producing the above-described cylinder block assembly. The method includes forming at least one cylinder bore in a first surface of a cylinder block, which is made from a first material. The first surface defines a cylinder head sealing surface. The method also includes forming at least one depression with a minimum depth of at least 0.01 mm in the cylinder head sealing around the cylinder bore. At least part of a running surface of the cylinder bore, at least part of the depression, and at least part of the cylinder head sealing surface are coated with a coating made of a second material that differs from the first material. The coating preferably has a truncated outer edge. A surface of a portion of the coating that covers the depression is level with an adjacent portion of the first surface that defines the cylinder head sealing surface.

The method may further include finishing a portion of the coating that covers the depression and a portion of the first surface that defines the cylinder head sealing surface to create a flat cylinder head sealing surface. The portion of the coating that covers the depression and the portion of the first surface that define the cylinder head sealing surface may be finished by grinding.

The method may further include forming a chamfer between the running surface of the cylinder bore and the first surface before coating the cylinder block. The chamber is subsequently coated with the coating.

The coating may be applied by plasma spraying. A lance of the plasma spraying apparatus is angled relative to a longitudinal direction of the cylinder bore during the coating of the chamfer.

The method may further include forming a recess for a cylinder head gasket in the cylinder head sealing surface before coating the cylinder block. The recess is covered when the coating is applied so that the coating does not get into the recess. The coating may be applied to the cylinder block over an entire surface that extends between the cylinder bore and an inner edge of the recess.

Additional and/or alternative advantages and salient features of embodiments of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a cross-sectional view of a cylinder block of an internal combustion engine according to one embodiment of the present invention;

FIG. 2 is an enlarged detail view of the transition area between the cylinder and cylinder head of FIG. 1; and

FIG. 3 is an enlarged detail view of a the transition area between the cylinder and cylinder head according to an alternative embodiment of the present invention.

### DETAILED DESCRIPTION OF PREFERRED EMBODIMENTS

By way of introduction, it should be stated that in the embodiments described herein, identical parts bear identical reference numbers or identical part identifiers. The various statements made in the overall description can be taken as applying to identical parts with identical reference numbers or identical part identifiers. Details with respect to position/attitude that are used for the description, i.e., above, below, lateral, etc., refer to the figure that has been directly shown or described and in the event of a change of position are to be transferred to the new position as appropriate. In addition, individual features or combinations of features from the embodiments that are shown and described can represent independent solutions that are inventive or according to the present invention.

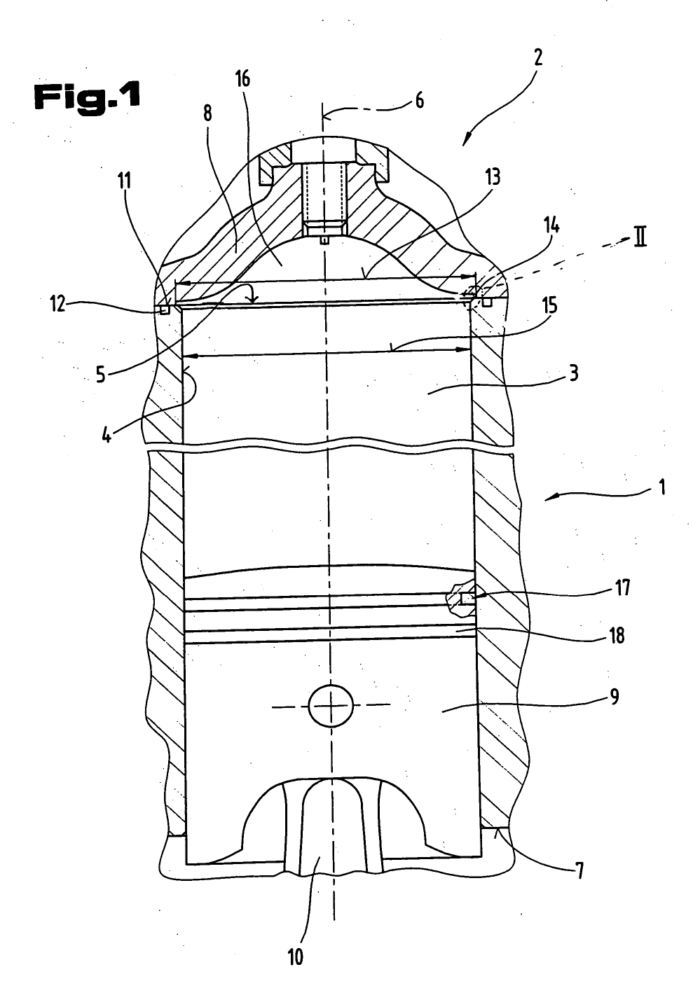

FIG. 1 is a cross section through a cylinder block 1 of an internal combustion engine 2. At least one cylinder bore 3 is arranged in the cylinder block 1 and this is defined laterally by a cylinder running surface 4. The cylinder bore 3 extends from a first upper surface 5 of the cylinder block 1 along a longitudinal mid-line axis 6 of the cylinder bore 3 in the direction of a second, lower surface 7 of the cylinder block 1. Within the vicinity of the first surface 5, the cylinder bore 3 is closed off by a cylinder head 8. A piston 9 moves up and down within the cylinder bore 3. The piston 9 connects to a crankshaft (not shown) through a connecting rod 10. Because cylinder blocks of this kind are well known to those of ordinary skill in the art, no further details about these features are provided. Inlet and exhaust passages, inlet and exhaust valves, and a cooling system have been omitted from FIG. 1 because these elements are well known in the art.

A sealing surface 11 for the cylinder head 8 is formed, in part, by the first surface 5 of the cylinder block 1. The sealing surface 11 is the surface of the cylinder block 1 that mates with the cylinder head 8. The sealing surface 11 serves to position the cylinder head 8 on the cylinder block 1. A cylinder head gasket 12 is arranged on the sealing surface 11 to form a seal between the cylinder bore 3 and the cylinder head 8. The cylinder head 8 has an inside diameter 13 in the area of 14 of the cylinder head sealing surface 11 (i.e., at the intersection between the cylinder head 8 and the sealing surface 11) that is greater than a diameter 15 of the cylinder bore 3 in this area 14. The cylinder head 8 mounts to the cylinder block 1 by way of connecting elements such as, for example, bolts (not shown herein).

A combustion chamber 16 is formed between the piston 9, the cylinder head 8, and the cylinder bore 3. At least one piston ring 18 is disposed in a groove 17 on the piston 9 to form a seal between the piston 9 and the cylinder bore 3.

The cylinder block 1 is an aluminum alloy, preferably of a Al—Si alloy, for example AlSi₉Cu₃. However, various other materials may alternatively be used without departing from the scope of the present invention.

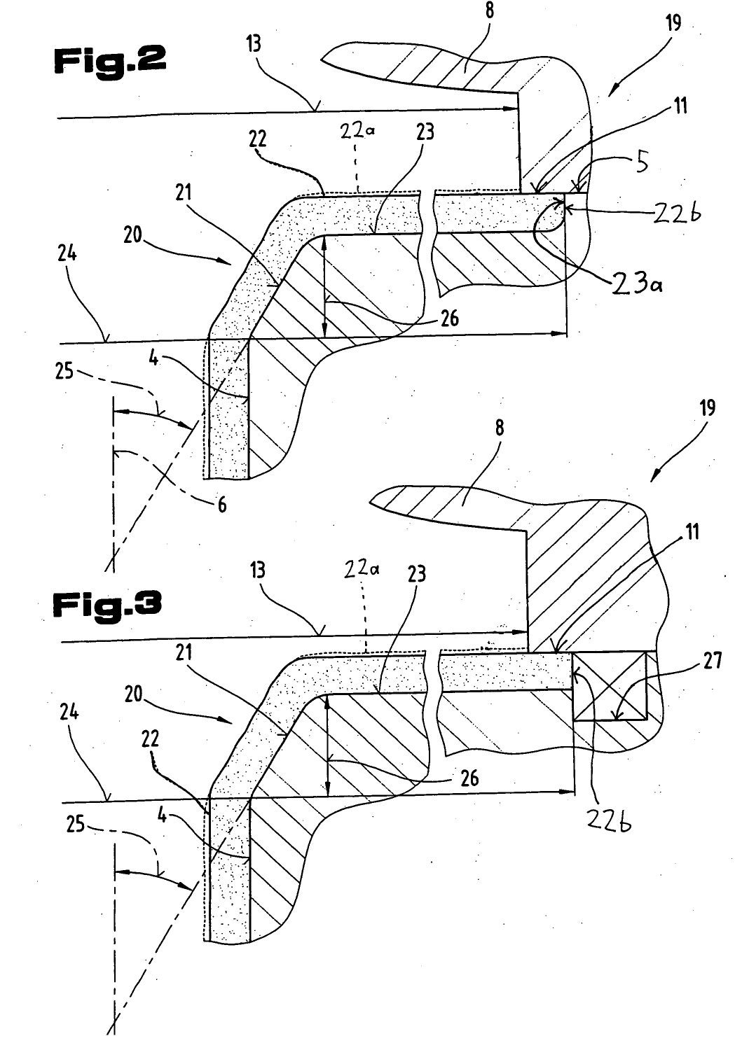

FIG. 2 shows a transition area 19 (indicated in FIG. 1 by a circle) between the cylinder bore 3 and the cylinder head sealing surface 11, which incorporates a circular chamfer 20. In this particular embodiment, the chamfer 20 is a truncated cone with a frusta-conical outer surface 21. This arrangement permits simple and cost-effective machining of the cylinder block 1 and the application of the coating 22, described below, using standard tools.

A depression 23 is formed in the surface 5 of the cylinder block 1 around the chamfer 20. Viewed radially in relation to the cylinder bore 3, a diameter 24 of the depression 23 is greater than the inside diameter 13 of the combustion chamber 16 in the area of the cylinder head sealing surface 11 (i.e., at the intersection between the cylinder head 8 and the sealing surface 11). The diameter 24 of the step or depression 23 is preferably between 2 mm and 6 mm greater than the diameter 15 of the cylinder bore 3. Relative to the surface 5 and in an axial direction of the cylinder bore 3, the depression 23 has a substantially uniform depth.

The depression 23 forms a step 23a with the surface 5 of the cylinder block 1. The depression 23 has a minimum depth relative to the surface 5 at the step 23a because of a slight curvature of the depression 23 at the step 23a. This minimum depth is preferably at least 0.01 mm, is more preferably at least 0.05 mm, and is more preferably at least 0.07 mm. The portion of the coating 22 that covers the depression 23 has a corresponding minimum thickness that is preferably at least 0.01 mm, is more preferably at least 0.05 mm, and is more preferably at least 0.07 mm. The step 23a of the depression 23 abuts an outer truncated edge 22b of the coating 22. The truncated edge 22b and step 23a may have abutting planar surfaces. Alternatively, the truncated edge 22b may have irregular contours, curves, or other shapes that help it to better adhere to the correspondingly shaped step 23a in the depression 23.

As shown in FIG. 2, the cylinder running surface 4 is provided with a coating 22. The coating 22 extends from the cylinder running surface 4 over the chamfer 20 and onto the depression 23. The depression 23 allows the coating 22 to be applied in a precisely defined area. It is preferred that the coating 22 be continuous, i.e., uninterrupted, and be of a second material that is different from a material used for the cylinder block 1. The second material can be of a material, which is more resistant to wear or harder than the material used for the cylinder block 1. For example, a ceramic material based, for example, on Fe oxides may be used. As a result, a separate cylinder liner is not necessary. The selection of this material can help prevent combustion residues from depositing on the surface of the cylinder bore 3.

The coating 22, the depression 23, and the surface 5 combine to define the cylinder head sealing surface 11. Alternatively, the coating 22 may extend radially outwardly on the surface 5 or the depression 23 sufficiently far that the coating 22 covers the entire sealing surface 11 of the surface 5.

Cavitation erosion can be eliminated almost completely because the coating 22 continues farther than the intersection between the cylinder head 8 and the cylinder block 1. The coating 22 shields the cylinder block 1 from exposure to the cavitating pressure that can form in the combustion chamber 16. Conversely, the cylinder head 8 and cylinder block 1 sandwich the coating 22 and prevent the coating 22 from separating from the cylinder block 1. The coating 22 is preferably finished so that it discourages combustion residues from depositing on the coating in the combustion chamber 16.

As illustrated in FIG. 2, the coating 22 can be of different thicknesses in the area of the cylinder bore 3, the surface of the frusta-conical body 21, and the cylinder head sealing surface 11. It is therefore possible to match the coating 22 thickness at any particular area to the mechanical and combustion forces exerted on that area to optimize the strength and the service life of the coating 22 and the cylinder block 1. The coating 22 is substantially uniformly thick over the width of the depression 23, including at the inner intersection between the cylinder head 8 and the sealing surface 11. The portion of the coating 22 that covers the depression 23 and the sealing surface 11 extends substantially in a plane that is perpendicular to the axis 6 of the cylinder bore 3. Alternatively, the coating 22 may form a taper or other shape in the correspondingly shaped depression 23 without deviating from the scope of the present invention.

The unfinished portions 22a of the coating 22 can be polished down in order to prevent combustion residues from being deposited in this area.

The frusta-conical surface 21 of the chamfer 20, which forms the transition area 19, is inclined towards the longitudinal mid-line axis 6 of the cylinder bore 3 at an opening angle 25. The opening angle 25 is preferably between about 15° and 70°, and is more preferably between about 15° and 55°, for example 45°. Other angles such as, for example, an opening angle 25 of between about 30° and 40°, may alternatively be used. As shown in FIG. 2, the chamfer 20 is arranged in such a manner that the frusta-conical body opens in the direction of the cylinder head 8. A height 26 of the chamfer 20 is preferably between about 0.1 mm and 2.5 mm, is more preferably between about 0.1 mm and 1.5 mm, and is even more preferably between about 0.4 mm and 1.0 mm (e.g., 0.8 mm) in the direction of the longitudinal midline axis 6.

The chamfer 20 may have a convex or curved shape without departing from the scope of the present invention. If the transition is convex, the stress resistance of the transition area of 19 can be matched to different types of engine operation. It is also possible to round off the transitions in the area between the cylinder surface 4 and the frusta-conical surface 21, as well as between the frusta-conical surface 21 and the depression 23. These features reduce the edge stresses exerted on the coating 22, which reduces the risk that the coating 22 will detach from the cylinder block 1.

FIG. 3 illustrates an alternative embodiment of the present invention. In this embodiment, an annular recess 27 encircles the cylinder bore 3. The recess 27 is machined into the surface 5 in order to accommodate the cylinder head gasket 12. During the coating process, the recess 27 can be used to accommodate a place holder which confines the radial extent of the coating 22. According to a preferred embodiment, the place holder is made of a coating repellent material.

Various other features of the previously described embodiment, such as the coated transition area 19 and application of a coating 22 to the depression 23 also apply to the embodiment shown in FIG. 3. A redundant description of these features is therefore omitted.

As is shown in FIG. 3, the coating 22 that partially defines the cylinder head sealing surface 11 extends as far as the recess 27. As is described below, appropriate measures can be taken to prevent this recess 27 from being coated when the coating 22 is applied.

The coating process is hereinafter described with reference to FIG. 2.

First, at least one cylinder bore 3 with the cylinder running surface 4 is made in the cylinder block 1. The transition area 19 between the cylinder surface 4 and the surface 5 is machined to a chamfer 20, and a partial area of the surface 5 is made with a depression (or step) 23.

Next, a coating 22, whose material differs from the cylinder block 1, is applied to the cylinder surface 4, the chamfer 20, and the depression 23. The coating 22 can be applied to these surfaces by plasma spraying. The plasma spraying can be carried out in different ways according to the processes known in the prior art. According to a preferred embodiment, the direction of the plasma spray is inclined in the transition area 19 between the cylinder surface 4 and the cylinder head sealing surface 11, so that the coating 22 is applied to the chamfer 20 approximately at a right angle. According to another preferred embodiment, this can be accomplished by either inclining a movable spraying device with respect to a stationary cylinder block or by inclining a movable cylinder block with respect to a stationary spraying device. This permits very precise coating of the chamfer 20, thereby making it possible to minimize the amount of coating 22 that is applied.

It is, of course, understood that any thermal coating method can be used without deviating from the scope of the present invention.

The coating 22 is applied to the depression 23, but not the remaining surface 5 of the cylinder block 1. An annular mask or other suitable covering may cover areas of the surface 5 (and recess 27 in the case of the embodiment illustrated in FIG. 3) during the coating process to prevent those areas from being coated. This means that it is not only possible to dispense with further processing of this recess, but it is also possible to define the lateral extent of the coating. Alternatively, the surface 5 may be left exposed and the excess coating 22 may be machined off of the surface 5 after the coating process.

Application of the coating 22 to the depression 23 but not the remaining surface 5 creates a cleaner end to the coating 22, so that under certain circumstances it is not necessary to mask the remaining surface during the coating process.

The surface 5 may alternatively be leveled without a step or depression 23. The coating 22 is then applied to the surface 5 over the entire area that defines the sealing surface 11. The coating 22 can then be machined to create a flat surface.

Finally, the coating 22 is then subjected to final finishing, which removes some of the excess and/or unfinished coating 22a. The surface 5 may also be finished (e.g., polished, ground, machined, etc.) so that the surface 5 and the coating 22 create a flat sealing surface 11 for the cylinder head 8. The level interface between the surface 5 and the surface of the coating 22 further reduces the risk that the coating 22 will separate from the cylinder block 1.

The surface 5 and coating 22 that form the sealing surface 11 may be finished together. This finishing process does not separate the coating 22 from the cylinder block 1 because the step 23a of the depression 23 protects the outer edge 22b of the coating 22 during finishing.

Final finishing is preferred because the initial coating process results in an uneven surface 22a, as is indicated by the dashed line in FIG. 2, which is neither suitable as a cylinder running nor as cylinder sealing surface. This final finishing can be effected, for example, in the area of the cylinder running surface 4, by honing and in the area of the cylinder head sealing surface 11 by grinding. If necessary, the individual surfaces of the coating can be subjected to different types of finishing so as to produce a variable roughness profile. As illustrated in FIG. 2, the portion of the coating 22 that covers the chamfer 20 may be optionally left unmachined to reduce machining costs. Alternatively, the portion of the coating 22 that covers the chamfer 20 may be finished via grinding, polishing, machining, etc.

The chamfer 20 covering portion of the coating 22 may be machined or polished such that it is smoother than a surface of the coating 22 that covers the running surface 4 of the cylinder bore 3. It is an advantage that, on one hand, deposits can be prevented from building up in the upper area of the cylinder bore 3 and, on the other hand, an adequate film of lubricant will be formed.

The portion of the coating 22 that covers the running surface 4 of the cylinder bore 3 is honed to ensure smooth movement of the piston 9 and piston ring 18 over the running surface 18.

Various components in the figures are out of scale (enlarged or reduced) so as to better illustrate the construction of the embodiments of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A cylinder block assembly for an internal combustion engine comprising:
a cylinder block having a cylinder bore formed therein extending from a first surface, wherein the cylinder bore has a cylinder bore surface, wherein the cylinder block is formed from a first material, and wherein the first surface defines a cylinder head sealing surface;
a cylinder head mounted to the cylinder head sealing surface; and
a coating covering at least part of the cylinder bore surface and at least part of the cylinder head sealing surface, the coating comprising a second material different than the first material, wherein the coating has a truncated outer edge.

2. The cylinder block assembly of claim 1, wherein a portion of the coating that covers the at least part of the cylinder head sealing surface has a minimum thickness of at least about 0.01 mm.

3. The cylinder block assembly of claim 1, wherein a portion of the coating that covers at least part of the cylinder head sealing surface extends radially outwardly from the cylinder bore in a plane that is perpendicular to an axis of the cylinder bore.

4. The cylinder block assembly of claim 1, wherein the coating extends radially outwardly at least 1 mm beyond the cylinder bore.

5. The cylinder block assembly of claim 1, wherein:
the cylinder block further comprises a chamfer formed in a transition area between the cylinder bore and the cylinder head sealing surface, and
the coating covers the chamfer.

6. The cylinder block assembly of claim 5, wherein the chamfer is frusta-conical, and a height of the frusta-conical chamfer in an axial direction of the cylinder bore is between 0.1 mm and 2.5 mm

7. The cylinder block assembly of claim 6, wherein the frusta-conical chamfer is inclined at an angle of between 15° and 70° to the cylinder bore.

8. The cylinder block assembly of claim 5, wherein the coating on the chamfer is not finished.

9. The cylinder block assembly of claim 1, wherein a depression is disposed in the first surface of the cylinder block, the depression surrounding the cylinder bore and being covered by the coating, and wherein the portion of the coating covering the depression has a surface that is level with an uncoated portion of the cylinder head sealing surface.

10. The cylinder block assembly of claim 9, wherein the depression has a diameter that is greater than an inside diameter of the cylinder head at the intersection between the cylinder head and the sealing surface.

11. The cylinder block assembly of claim 9, wherein a portion of the coating that covers the depression is finished.

12. The cylinder block assembly of claim 9, wherein the depression has a substantially uniform depth.

13. The cylinder block assembly of claim 9, wherein the depression has a minimum depth, relative to the first surface, of at least 0.01 mm.

14. The cylinder block assembly of claim 9, wherein the depression has a step that abuts the truncated outer edge of the coating.

15. The cylinder block assembly of claim 1, wherein a recess for a cylinder head gasket is formed in the cylinder head sealing surface of the cylinder block and surrounds the cylinder bore.

16. The cylinder block assembly of claim 15, wherein the coating extends outwardly over the cylinder head sealing surface to an inner edge of the recess.

17. A cylinder block assembly for an internal combustion engine comprising:
a cylinder block having a cylinder bore formed therein extending from a first surface, wherein the cylinder bore has a cylinder bore surface, wherein the cylinder block is formed from a first material, and wherein the first surface defines a cylinder head sealing surface;
a cylinder head mounted to the cylinder head sealing surface; and
a coating covering at least part of the cylinder bore surface and at least part of the cylinder head sealing surface, the coating comprising a second material different than the first material, wherein a portion of the coating that covers at least part of the cylinder head sealing surface has a substantially uniform thickness.

18. A method for producing a cylinder block for an internal combustion engine comprising:
forming at least one cylinder bore in a first surface of a cylinder block comprising a first material, the first surface defining a cylinder head sealing surface;
forming at least one depression with a minimum depth of at least 0.01 mm in the cylinder head sealing around the cylinder bore; and
coating at least part of a running surface of the cylinder bore and at least part of the depression in the cylinder head sealing surface with a coating, which comprises a second material that differs from the first material, in such a way that a surface of a portion of the coating that covers the depression is level with an adjacent portion of the first surface that defines the cylinder head sealing surface.

19. The method of claim 18, wherein the depression defines a step between the depression and the first surface, wherein the coating has a truncated outer edge, and wherein the coating is applied such that the truncated outer edge abuts the step.

20. The method of claim 18, wherein the portion of the coating that covers the depression and the portion of the first surface that define the cylinder head sealing surface are finished by grinding.

21. The method of claim 18, further comprising:
forming a chamfer between the running surface of the cylinder bore and the first surface before coating the cylinder block; and
subsequently coating the chamfer with the coating.

22. The method of claim 21, wherein the coating is applied by plasma spraying and a lance of the plasma spraying apparatus is angled relative to a longitudinal direction of the cylinder bore during the coating of the chamfer.

23. The method of claim 18, further comprising:
forming a recess for a cylinder head gasket in the cylinder head sealing surface before coating the cylinder block; and
covering the recess when the coating is applied.

24. The method of claim 23, wherein the coating is applied to the cylinder block over an entire surface that extends between the cylinder bore and an inner edge of the recess.
